(19) United States
(12) Patent Application Publication
(10) Pub. No.: US 2015/0066566 A1
(43) Pub. Date: Mar. 5, 2015

(54) BALANCING SUPPLY AND DEMAND USING DEMAND-SHAPING ACTIONS

(71) Applicant: INTERNATIONAL BUSINESS MACHINES CORPORATION, ARMONK, NY (US)

(72) Inventors: THOMAS R. ERVOLINA, Yorktown Heights, NY (US); Markus Ettl, Yorktown Heights, NY (US); Roger D. Lederman, Yorktown Heights, NY (US); Marek Petrik, Yorktown Heights, NY (US); Rajesh Kumar Ravi, Yorktown Heights, NY (US)

(73) Assignee: INTERNATIONAL BUSINESS MACHINES CORPORATION, ARMONK, NY (US)

(21) Appl. No.: 14/015,592

(22) Filed: Aug. 30, 2013

(51) Int. Cl. G06Q 10/06

(52) U.S. Cl. CPC G06Q 10/06315
USPC 705/7.25

(57) ABSTRACT

A method for balancing supply and demand for a product using demand-shaping action includes identifying an imbalance between supply and demand for a given product. A customer choice model is generated based on collected historical sales data pertaining to the given product and at least one product similar to the given product. The customer choice model is configured to estimate, for a given customer or group of customers, a likelihood of effecting a substitution between each product pair of the given product and the at least one product similar to the given product, for each of one or more available demand shaping actions. One or more of the available demand shaping actions are automatically selected to minimize an estimate of revenue shortfall or inventory holding costs resulting from the identified imbalance between supply and demand.

### TECHNICAL FIELD

The present disclosure relates to balancing supply and demand and, more specifically, to balancing supply and demand using demand-shaping actions.

### DISCUSSION OF RELATED ART

Today manufacturers are increasingly focused on lean inventory. Goods are manufactured in controlled quantities to satisfy estimated demand while minimizing inventory. While this approach may ordinarily prove to be optimal, the opportunity exists, at least for the short term, for significant supply/demand imbalances to occur. For example, a particular product may experience unexpectedly high demand. Demand estimates may be updated to reflect unexpected consumer demand but increased production may be difficult to implement in a timely fashion and in the interim, sales may be lost to competing goods.

### BRIEF SUMMARY

A method for balancing supply and demand for a product using demand-shaping action includes identifying an imbalance between supply and demand for a given product. A customer choice model is generated based on collected historical sales data pertaining to the given product and at least one product similar to the given product. The customer choice model is configured to estimate, for a given customer or group of customers, a likelihood of effecting a substitution between each product pair of the given product and the at least one product similar to the given product, for each of one or more available demand shaping actions. One or more of the available demand shaping actions are automatically selected to minimize an estimate of revenue shortfall or inventory holding costs resulting from the identified imbalance between supply and demand.

Automatically selecting one or more of the available demand shaping actions may include optimizing selection of demand shaping actions to maximize profit from the combined sale of the given product and the at least one product similar to the given product. The optimizing may be performed based on a stochastic view of demand forecasts. The optimizing may utilize a Markov decision process.

The identified imbalance between supply and demand for the given product may include determining that an estimated availability of the product is insufficient to meet an estimated demand for the product or determining that an estimated availability of the product is substantially greater than the estimated demand for the product.

The collected historical sales data may include past customer purchase history.

The collected historical sales data may include data pertaining to effectiveness of the available demand shaping actions in influencing customer preferences related to the given product and the at least one product similar to the given product.

The one or more available demand shaping actions may include reducing a price of the given product or the at least one product similar to the given product or altering a stated lead-time or availability status of the given product or the at least one product similar to the given product.

The one or more available demand shaping actions may include offering additional products or services along with the purchase of the given product or the at least one product similar to the given product or altering a stated lead-time or availability status of the given product or the at least one product similar to the given product.

The one or more available demand shaping actions may include providing information comparing the given product to the at least one product similar to the given product.

The one or more available demand shaping actions may include increasing the price of the given product or the at least one product similar to the given product.

The selected one or more of the available demand shaping actions may be implemented.

A method for balancing supply and demand for a product using demand-shaping action includes identifying when an estimated quantity demanded for a given product exceeds an ability to manufacture the product within a window of time due to limited availability of at least one component of the given product or when an estimated quantity demanded for the given product falls substantially short of a planed supply of the product. A customer choice model is generated based on collected historical sales data pertaining to the given product and at least one product similar to the given product. The customer choice model is configured to estimate, for a given customer or group of customers, a likelihood of effecting a substitution between each product pair of the given product and the at least one product similar to the given product, for each of one or more available demand shaping actions. One or more of the available demand shaping actions is automatically selected to promote customer substitution from the given product to the at least one product similar to the given product.

The at least one product similar to the given product might not include the at least one component having limited availability

Automatically selecting one or more of the available demand shaping actions may include optimizing selection of demand shaping actions to maximize profit from the combined sale of the given product and the at least one product similar to the given product.

The optimizing may be performed based on a stochastic view of demand forecasts.

The optimizing may utilize a Markov decision process.

The collected historical sales data may include past customer purchase history.

The collected historical sales data may include data pertaining to effectiveness of the available demand shaping actions in influencing customer preferences related to the given product and the at least one product similar to the given product.

The one or more available demand shaping actions may include reducing a price of the given product or the at least one product similar to the given product or altering a stated lead-time or availability status of the given product or the at least one product similar to the given product.

The one or more available demand shaping actions may include offering additional products or services along with the purchase of the given product or the at least one product similar to the given product or altering a stated lead-time or availability status of the given product or the at least one product similar to the given product.

The one or more available demand shaping actions may include providing information comparing the given product to the at least one product similar to the given product.

The one or more available demand shaping actions may include increasing the price of the given product or the at least one product similar to the given product.

The selected one or more of the available demand shaping actions may be implemented.

A computer program product for balancing supply and demand for a product using demand-shaping action includes a computer readable storage medium having program code embodied therewith. The program code readable/executable by a computer to identify an imbalance between supply and demand for a given product. A customer choice model is generated based on collected historical sales data pertaining to the given product and at least one product similar to the given product. The customer choice model is configured to estimate, for a given customer or group of customers, a likelihood of effecting a substitution between each product pair of the given product and the at least one product similar to the given product, for each of one or more available demand shaping actions. One or more of the available demand shaping actions are automatically selected to minimize an estimate of revenue shortfall or inventory holding costs resulting from the identified imbalance between supply and demand.

Automatically selecting one or more of the available demand shaping actions may include optimizing selection of demand shaping actions to maximize profit from the combined sale of the given product and the at least one product similar to the given product. The optimizing may be performed based on a stochastic view of demand forecasts. The optimizing may utilize a Markov decision process.

The identified imbalance between supply and demand for the given product may include determining that an estimated availability of the product is insufficient to meet an estimated demand for the product or determining that an estimated availability of the product is substantially greater than the estimated demand for the product.

The collected historical sales data may include past customer purchase history.

The collected historical sales data may include data pertaining to effectiveness of the available demand shaping actions in influencing customer preferences related to the given product and the at least one product similar to the given product.

The one or more available demand shaping actions may include reducing a price of the given product or the at least one product similar to the given product or altering a stated lead-time or availability status of the given product or the at least one product similar to the given product.

The one or more available demand shaping actions may include offering additional products or services along with the purchase of the given product or the at least one product similar to the given product or altering a stated lead-time or availability status of the given product or the at least one product similar to the given product.

The one or more available demand shaping actions may include providing information comparing the given product to the at least one product similar to the given product.

The one or more available demand shaping actions may include increasing the price of the given product or the at least one product similar to the given product.

The selected one or more of the available demand shaping actions may be implemented.

A computer program product for balancing supply and demand for a product using demand-shaping action includes a computer readable storage medium having program code embodied therewith. The program code readable/executable by a computer to identify when an estimated quantity demanded for a given product exceeds an ability to manufacture the product within a window of time due to limited availability of at least one component of the given product or when an estimated quantity demanded for the given product falls substantially short of a planed supply of the product. A customer choice model is generated based on collected historical sales data pertaining to the given product and at least one product similar to the given product. The customer choice model is configured to estimate, for a given customer or group of customers, a likelihood of effecting a substitution between each product pair of the given product and the at least one product similar to the given product, for each of one or more available demand shaping actions. One or more of the available demand shaping actions is automatically selected to promote customer substitution from the given product to the at least one product similar to the given product.

The at least one product similar to the given product might not include the at least one component having limited availability

Automatically selecting one or more of the available demand shaping actions may include optimizing selection of demand shaping actions to maximize profit from the combined sale of the given product and the at least one product similar to the given product.

The optimizing may be performed based on a stochastic view of demand forecasts.

The optimizing may utilize a Markov decision process.

The collected historical sales data may include past customer purchase history.

The collected historical sales data may include data pertaining to effectiveness of the available demand shaping actions in influencing customer preferences related to the given product and the at least one product similar to the given product.

The one or more available demand shaping actions may include reducing a price of the given product or the at least one product similar to the given product or altering a stated lead-time or availability status of the given product or the at least one product similar to the given product.

The one or more available demand shaping actions may include offering additional products or services along with the purchase of the given product or the at least one product similar to the given product or altering a stated lead-time or availability status of the given product or the at least one product similar to the given product.

The one or more available demand shaping actions may include providing information comparing the given product to the at least one product similar to the given product.

The one or more available demand shaping actions may include increasing the price of the given product or the at least one product similar to the given product.

The selected one or more of the available demand shaping actions may be implemented.

### BRIEF DESCRIPTION OF THE SEVERAL VIEWS OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic diagram illustrating demand shaping in accordance with exemplary embodiments of the present invention;

FIG. 2 is a schematic diagram illustrating an approach for demand shaping optimization in accordance with exemplary embodiments of the present invention;

FIG. 3 is a flow chart illustrating an approach for automatically balancing supply and demand using demand-shaping action in accordance with exemplary embodiments of the present invention; and

FIG. 4 shows an example of a computer system capable of implementing the method and apparatus according to embodiments of the present disclosure.

### DETAILED DESCRIPTION

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention seek to provide an automated approach for optimizing demand-shaping actions to better align demand with supply. Such approaches may be successfully utilized, especially in the short term, so that demand for any given product does not significantly outstrip supply, at least until supply can be adequately ramped up.

A given producer may offer a portfolio of goods and consumers may have some inclination to substitute between goods of the same portfolio. This inclination to substitute may be influenced by demand shaping actions. By automatically shaping the demand for the goods within the portfolio, consumers may be incentivized to buy those goods that have adequate supply over those goods that are in short supply so that the number of consumers that are unable to buy a desired product are minimized and fewer sales are lost to competing producers.

Additionally, where one or more components are in short supply, demand may be shaped to steer consumers to those end products that do not utilize the scarce components over those that do.

Demand shaping, as discussed herein, is the ability to sense changing demand patterns, evaluate and optimize an enterprise supply plan to best support market demand and opportunity, and execute a number of actions to influence consumer demand so that the demand better aligns with an optimized plan.

A multi-enterprise cloud-based data model called the Demand Signal Repository (DSR) may be used to automatically assess and optimize demand shaping actions. The DSR may define a tightly linked end-to-end product dependency structure and may provide a trusted source of demand and supply levels across the extended supply chain, which includes end products, components and sub-components thereof. Exemplary embodiments of the present invention may also provide a suite of mathematical optimization models that enable on demand up-selling, alternative-selling and down-selling to better integrate the supply chain horizontally, connecting the interaction of customers, business partners and sales teams to procurement and manufacturing capabilities of a firm.

Imbalances between supply and demand may degraded supply chain efficiency, often resulting in delinquent customer orders, missed revenue, and excess inventory. Exemplary embodiment of the present invention provide supply chain planning and execution processes that incorporate demand shaping and profitable demand response to drive better operational efficiency of the supply chain. These approaches are aimed at finding marketable product alternatives that replace demand on supply-constrained products while minimizing expected stock-out costs for unfilled product demand and holding costs for left-over inventory. Rather than emphasizing Available-To-Promise (ATP), where a scheduling system determines a particular product's availability, exemplary embodiments of the present invention provide a customer-centric approach based on customer choice modeling and demand shaping to dynamically incorporate product substitutions and up-sell opportunities into the supply-demand planning process.

Demand shaping is a demand-driven, customer centric approach to supply chain planning and execution. The aim of demand shaping is to align customer's demand patterns with a firm's supply and capacity constraints through better understanding of customer's preferences which helps influencing customer's demand towards products that the firm can supply easily and profitably. Demand shaping can be accomplished, for example, through the levers of price, promotions, sales incentives, product recommendations, or on the spot upgrades/discounts to enable sales teams to close deals for in-stock products.

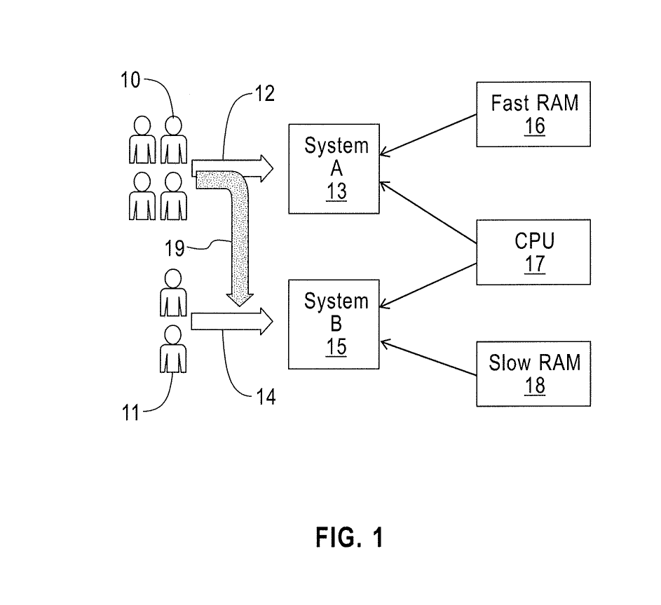

FIG. 1 is a schematic diagram illustrating demand shaping in accordance with exemplary embodiments of the present invention. As can be seen from this figure, a relatively large group of consumers 10 has a relatively large demand 12 for System A 13, which includes components of Fast RAM 16 and a CPU 17. A smaller group of consumers 11 has a relatively small demand 14 for System B 15, which includes components of Slow RAM 18 and the CPU 17. It may be automatically determined that the Fast RAM 16 is in short supply. Accordingly, exemplary embodiments of the present invention may shape the consumers 10 demand 12 for System A 13, which includes the Fast RAM 16 that is in short supply to divert demand 19 to System B 15, which does not include the Fast RAM 16.

Exemplary embodiments of the present invention seek to understand and influence demand by performing the following analyses (1) customer preference and demand pattern recognition, (2) supply capability analysis that provides increased visibility to the sales force on in-stock and out-of-stock products, (3) optimal demand shaping based on advanced customer analytics that estimate propensities of customers to purchase alternate products so that the sales force can guide customers to “next-best” product options.

Detecting customer preferences and demand patterns may utilize predictive analytics and automated gathering of sales data from multiple customer touch points, for example, retailer point-of-sales data, channel partner data, and shopping basket or checkout data from e-Commerce sales portals. Such data may be stored in a Demand Signal Repository (DSR), which may be a cross-enterprise database that stores sales data in a format that allows for easy retrieval of information so that a firm can easily query the database to identify what is selling, where it is selling, when it is selling and how it is being sold. Supply capability analysis provides timely information on available product supply to identify imbalances between customer demand and available supply.

Once an imbalance has been identified, customer demand may be steered to a preferred set of products that optimizes the firm's profitability and revenue while increasing overall serviceability and customer satisfaction.

Various mathematical models may be used to guide demand shaping. These models aim to find marketable product alternatives in a product portfolio that best utilize inventory surplus and replace demand on supply-constrained products. Customer expectations may be analyzed in a dynamic setting utilizing a customer choice model that determines how customers evaluate product substitutions if their initial product selection is unavailable. Numerical results may be used to quantify the business value of demand shaping in a configure-to-order (CTO) supply chain where end products are configured from pluggable components, such as hard disks, microprocessors, video cards, etc., an environment where demand shaping may be particularly effective.

In addition to the product-level demand patterns that can be derived from sales data collected at customer touch points, exemplary embodiments of the present invention may generate and utilize a detailed model of customer decision-making that can be used to predict the success rate of various shaping actions. Customers' product choices may be modeled using a discrete-choice framework that casts the likelihood of all possible purchase decisions within a parametric form. This framework may incorporate product attributes, customer characteristics, and additional market signals that may effect customer decisions. The resulting customer choice model may depict latent inter-product relationships, and the customer choice model may be combined with up-to-date product-level forecasts to give a fuller picture of demand.

Product demand forecasts and customer choice modeling may be integrated into a two-stage decision process for customer purchases. The first stage occurs prior to demand shaping and involves determination of an unshaped product choice for each customer. It may be assumed that the distribution of unshaped product choices is, with the exception of some random forecast error, represented accurately by product demand forecasts that are generated through the traditional planning process. A second decision stage may then be generated in which some portion of this forecasted demand is re-allocated by various shaping actions that are applied across the product portfolio. The end result is may be a shaped demand that is expected as a result of shaping. The customer choice model is used to predict the degree of redistribution that can be achieved through each possible set of shaping actions.

Customer choice analytics may be used to support optimization of shaping actions by generating a matrix of substitution probabilities to reflect the rate of demand redistribution between product pairs for any potential collection of shaping actions. To start, customers are segmented by a combination of customer characteristics and unshaped product choice. The set Y provides a collection of observable customer profiles, used to group customers by attributes such as, e.g., sales channel, industry segment, length of relationship, etc. For each type yεY, at time tεT, an unshaped forecast F_{tyj} of demand for each product j in the product portfolio J may be obtained. This allows a further segmentation by unshaped product choice, so that shaping actions are targeted at a segment sεY×J, with a forecasted segment size nₛₜ equal to the corresponding unshaped forecast. Let S=V×J and partition so that S_{y} contains those segments with customer type y.

For each segment s, there may be a set Aₛ of admissible shaping actions. An example of a possible shaping action in Aₛ is to “offer product i to segment s customers at a 20% discount”. As each segment relates to a specific unshaped product choice j, actions for that product are intended to redistribute some portion of product j's demand to elsewhere in the portfolio. Since multiple actions may be applied simultaneously, an action profile hₛεHₛ⊂2^{A}, may be defined to characterize the full set of shaping activities targeted at segment s. For each action profile, the optimizer may be provided with the following representation of demand redistribution: Vₛ(hₛ), which may be a |J|-vector of substitution probabilities, such that Vₛₜ is the proportion of the unshaped demand from segment s that is redistributed to product i when the action profile hₛ is applied.

As a result, the predicted shaped demand for any set of segment-specific action profiles may be represented as

$${\tilde{F}}_{ty} ( {\{ {h}_{s} \}}_{s ∈ S} ) = {\sum }_{s ∈ {S}_{y}} {n}_{si} {V}_{s} ( {h}_{s} ) ,$$

where \tilde{F}_{yt} itself is a |J|-vector of shaped product demands.

The vector Vₛ (hₛ) may then be decomposed into the product of a substitution-structure vector Bₛ(hₛ), and a substitution-rate parameter δε[0,1]. The parameter δ is a measure of the overall substitutability between products in the market. The effectiveness of shaping may be dependent on having a relatively high value for δ. However, in accordance with exemplary embodiments of the present invention, Bₛ (•) may be estimated from historical orders and customer data.

For any given number of products and actions, the large number of required substitution probabilities may make direct estimation of these values prohibitive. Instead, exemplary embodiments of the present invention derive terms from a discrete-choice model containing far fewer parameters. This approach may be able to accurately represent customer heterogeneity. In particular, substitution patterns reflect the degree to which products draw from overlapping customer pools, which can be captured meaningfully through a heterogeneous model. To this end, a mixed logit model of demand which extends a standard logit model to incorporate variation in customer preferences may be employed.

A demand model for each customer type y, may be fit using historical orders from the customer set K_{y} over the time horizon, T_{Hist}. As with the standard logit model, the mixed logit model predicts order probabilities as a function of product attributes. At time t, customer k has a stochastic valuation of each product j,

denoted uₖⱼₜ=αₖ^{T}xⱼ+βₖzₖⱼₜ+εⱼₖₜ, where xⱼ contains product attributes, zₖⱼₜ contains information on shaping actions applied at time t, {αₖ,βₖ} are model parameters to be estimated, and εₖⱼₜ is a stochastic error term. For example, where the product being modeled is a computer server, attributes in xⱼ include, e.g., CPU speed, hard drive capacity, hard drive speed, and GB of memory. The second data term, zₖⱼₜ, contains factors impacting purchasing that may be manipulating through shaping actions. In the simplest case zₖⱼₜ equals the price pₖⱼₜ, but this vector can be expanded to encompass quoted order lead-times, marketing intensity, and other relevant factors.

Under the logit assumption that εₖⱼₜ are independent and identically distributed extreme-value distributed, the likelihood of purchase for product j, assuming a choice-set Jₖₜ of available products, is:

$${L}_{kjt \vert {J}_{kt}} ( α , β , x , z ) = {e}^{{α}_{k}^{T} {x}_{j} + {β}_{k} {z}_{kjt}} / ( 1 + {\sum }_{i ∈ {J}_{kt}} {e}^{{α}_{k}^{T} {x}_{i} + {β}_{k} {z}_{kjt}} ) .$$

According to alternate approaches, α and β are constant across customers. The mixed logit model according to exemplary embodiments of the present invention allows for these values to vary across the population according to a specified mixing distribution G_{y}(α,β|θ), whose parameters can in turn be estimated. This can be a continuous distribution, i.e. a normal or lognormal distribution, or a discrete distribution, which then gives rise to distinct latent customer segments. In practice, a discrete component of preference variation, which introduces multi-modality into the preference distribution, may be combined with a continuous component that is more economical in its use of parameters. The full parameter vector θ is then estimated along with a and β using a maximum likelihood procedure with the historical order set. In this case, simulation may be used to evaluate E_{G}_{_{y}}[L_{kjt|J}_{ₖₜ}], since this quantity no longer has a closed form.

Under the mixed model of demand, customers' unshaped product choices reflect on their personal values of α and β, giving insight into each customer's sensitivity to shaping actions, and the likelihood of accepting specific substitutes. By conditioning the mixing distribution on each customer's unshaped product choice j, or more generally, on their history of product choices, an individualized mixing distribution, G_{y|j}, may be obtained that is used to assess various targeted action profiles. For example, a shaping attribute vector \tilde{z}(hₛ) and an alternative product set \tilde{J}(hₛ) may be associated with each action profile hₛ. The likelihood of a segment s customer, where this dictates a type y and unshaped choice j, accepting substitute i when shaping profile hₛ is applied, is then provided by the expected value E_{G}_{_{y|i}}[L_{kit|J}_{ₖₜ}₍ₕ_{ₛ}₎(α, β, x, \tilde{z} (hₛ))]. This quantity may be computed to populate the i^{th} entry in Bₛ(Hₛ).

Exemplary embodiments of the present invention may utilize one or more optimization models for automatically selecting recommended shaping actions. The optimization may be based on a stochastic view of demand forecasts and may be formulated as a Markov decision process. Because of the large size of the model, it may be solved using approximate dynamic programming.

As described above, demand is shaped in the context of a manufacturer which purchases and inventories individual components and then uses them to assemble and sell products. The demand is shaped over a sequence of time periods, which is indexed as t=1, 2, . . . . The set of all component types is denoted by C and the set of all products, as above, is denoted by J. The bill of material is represented by U; that is each product jεJ is assembled of U(j, c) components of type c Components that are not sold are inventoried; the inventory of a component c at time t is denoted Iₜ(c).

The planning horizon is infinite and future returns are discounted by a given discount factor γ. The purchase of each component is subject to a moderate lead-time l, which we assume to be identical across components. The order size is not changed once it is placed.

Demand shaping, as considered herein, may be used to address two main types of the supply-demand imbalance: 1) deterministic imbalance, and 2) stochastic imbalance. A deterministic imbalance is known in advance of the lead time for most components, but the supply constraints do not allow to fully satisfy the demand. This kind of imbalance typically occurs after an introduction of a new product and/or during a long-term component shortage and it may be mitigated deterministically in advance. Stochastic imbalance is not known in advance and only becomes known after it is too late to adjust component supply. This kind of imbalance can be caused by an incorrect demand forecast, an unexpected last-minute supply disruption, and/or incorrect planning.

Deterministic and stochastic imbalances in the supply chain not only have separate causes, but also require different solution approaches. Since a deterministic imbalance is known within the lead-time of most components, the demand can be shaped into other products and the supply can be adjusted accordingly. Since a stochastic imbalance occurs only after it is too late to modify the component supply, it can only be mitigated by keeping appropriate inventories and shaping the excess demand into products that are available in the inventory. The model described here addresses both deterministic and stochastic supply-demand imbalances.

Components are ordered based on a build-to-order supply policy. For example, the supply matches the expected demand. This assumption is made to simplify the model; in most actual applications, the orders would be based on the solution of a newsvendor optimization problem. The actual solution used is based on approximate dynamic programming and in essence generalizes the news-vendor solution to multiple stages. Since the supply is assumed to match the product demand, the component supplies may be ignored in this model. In addition, all unused components may be automatically inventoried with no expiration.

The customer-choice model may be modeled for each customer. For example, the set S represents the customer segments with a forecasted size nₛₜ at time t for a segment s. The forecast is assumed to be made at time t−l, the latest time when the supply can be adjusted. Because the forecast is made in advance, stochastic disturbances Δₜ in demand may be allowed for, which will lead to imbalances between supply and the unshaped demands. As a result, the realized segment size is a random variable Nₛₜ with mean nₛₜ. The realization of this value at time t becomes known only at time t+1.

The realized demand disturbances are normally distributed with mean 0. The distribution used in the model can be arbitrary and can be fit to historical data. The variance of this distribution depends on an external stochastic process of demand variability. Here, we consider a single-dimensional model of variability, denoted θ. The variability itself evolves as a normally distributed martingale with fixed variance and zero mean. The demand disturbances A across the products are usually negatively correlated with a larger variance in individual products than the total demand. Here Δ_{θ} may be used to denote the covariance matrix.

The realized, unshaped customer demand is modified by taking shaping actions from the set Hₛ; which includes a no-shaping action option. As described above, the probability of a customer from segments buying a product i after a shaping action hₛ is taken is Vₛᵢ(hₛ). Applying action profiles {hₛ}_{sεS} at time t results in a realized, shaped demand of \tilde{D}_{ty}=Σ_{sεS}_{_{y}}NₛₜVₛ(h_{g}). At the start of the horizon, \tilde{D}_{ty} is a random vector, whose realization will depend on realized values of Nₛₜ for sεS_{y}.

The inventory of component type c is subject to a per-item holding cost c_{H}(c). Taking any shaping action h carries a fixed cost c_{S}(h), for example the cost of advertising, and variable costs c_{V}(h), for example, product discounts, which are a function of the segment size. The marginal profit for a product j is c_{M}(j). Finally, the customer model assumes no backlogging and all demand that cannot be satisfied is lost. The overall objective is then to minimize the sum of lost sales due to the product being unavailable, the cost of shaping actions, and the holding costs.

The stochastic optimization problem may be formulated. If desired, specific action profiles may be applied to only a portion of a segment. As such, decision variables πₜ represent the probability of taking each shaping action hₛ at every time step t for each segment s. These probabilities are denoted as πₜ(s,hₛ).

The main optimization problem in demand-shaping is stochastic due to the uncertain nature of the demand forecasts and can be modeled as a Markov decision process (MDP). The Markov state at time t is represented by the inventory of all products, the demand variability, and the demand forecast. Demand forecast evolves stochastically as described above; the demand variability evolves as a martingale. The Bellman optimality condition for a value function vₜ(Iₜ,θₜ,nₜ) is as follows:

$${v}_{t} ( {I}_{t} , {ϑ}_{t} , {n}_{t} ) = {min}_{{π}_{1} , {q}_{1}} E [ \begin{matrix}{\sum }_{c ∈ C} {c}_{H} ( c ) \cdot {I}_{t} ( c ) + {\sum }_{j ∈ J} {c}_{M} ( j ) \cdot min \{ {q}_{t} ( j ) , {\sum }_{y ∈ Y} {\tilde{D}}_{tyj} \} + \\ + {\sum }_{s ∈ S} {\sum }_{h ∈ H} {π}_{1} ( s , {h}_{s} ) \cdot ( {c}_{s} ( {h}_{s} ) + {c}_{V} ( {h}_{s} ) \cdot {N}_{s , 1} ) + \\ + γ \cdot {v}_{t + 1} ( {I}_{t + 1} , {ϑ}_{t + 1} , {n}_{t + 1} )\end{matrix} ] \qquad Eq . ( 1 )$$

Here, we use qᵢ(j) to represent how many products can be build from the available components and yε(0,1) to represent the discount factor.

The optimization variables in the problem above are constrained as follows. The first constraint ensures that the shaped demands \tilde{D} are based on the shaping action probabilities π:

$${\tilde{D}}_{tyj} = {\sum }_{s ∈ {S}_{y}} {\sum }_{{h}_{s} ∈ {H}_{s}} {N}_{si} \cdot {V}_{sj} ( {h}_{s} ) \cdot {π}_{i} ( s , {h}_{s} ) for all y ∈ Y and j ∈ J .$$

The second constraint ensures that the number of the products sold corresponds to the inventory of each component type:

qₜ(j)·U(j,c)≦Iₜ(c) for all jεJ and cεC.

Note that due to the assumption of the supply matching the deterministic demand n, it may be assumed that the demand with no shaping is 0. This assumption allows for the effects of stochastic imbalances to be studied alone and they can be easily relaxed. There are additional constraints that ensure that the probabilities of shaping actions in each segment sum to 1 and that the inventories are correctly tracked across time periods.

The optimization problem in Eq. (1) may be too large to be solved directly because the value function is defined for continuously many states. Instead, the MDP may be solved using approximate linear programming, which is a version of approximate dynamic programming. Normal distributions may be approximated by the Gauss-Hermite quadrature. The shaping decisions are then chosen greedily with respect to the approximate value function.

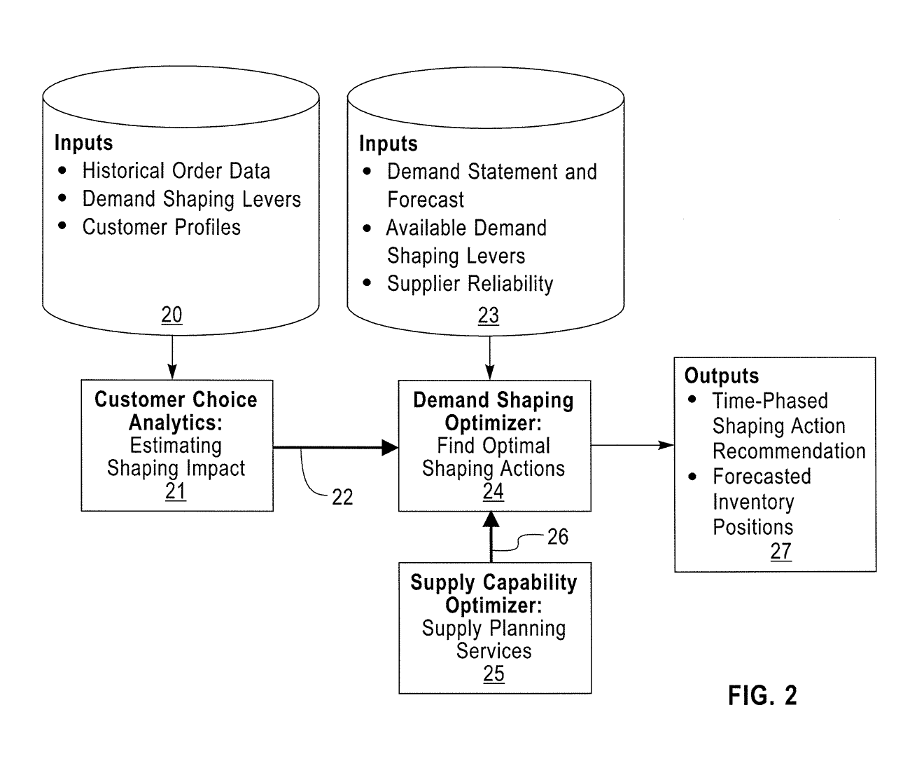

FIG. 2 is a schematic diagram illustrating an approach for demand shaping optimization in accordance with exemplary embodiments of the present invention. As described above, a customer choice model may be generated for predicting, for each given customer, a likelihood for that customer to be successfully persuaded to transition from one product to another product for each possible product pair based on each available shaping action. The generation and utilization of this customer choice model is considered to be customer choice analytics 21, and it may be used to estimate the impact of demand shaping. This customer choice model may be based on various inputs 20, for example, including historical order data, demand shaping levers and customer profiles.

The result of the customer choice analytics 21, for example, the output of the customer choice model, may be an expression of a propensity for each customer to switch products, for each product pair, for each available shaping action 22. These values may be used by a demand shaping optimizer 24, whose job it may be to find the optimal shaping actions to take to mitigate the mismatch of supply and demand to the greatest extent practical. The demand shaping optimizer 24, in addition to receiving the propensity information 22, may take various inputs 23 including, for example, demand statements and forecasts, available demand shaping levers, and supplier reliability. The demand shaping optimizer 24 may also utilize various supply commits 26 provided by a supply capability optimizer 25, which provides various supply planning services.

The demand shaping optimizer 24 may then solve the optimization problem to find the optimal demand shaping actions to best mitigate the mismatch. In so doing, the output 27 of the demand shaping optimizer 24 may include providing time-phased shaping action recommendations and forecasted inventory positions based on following the provided recommendations.

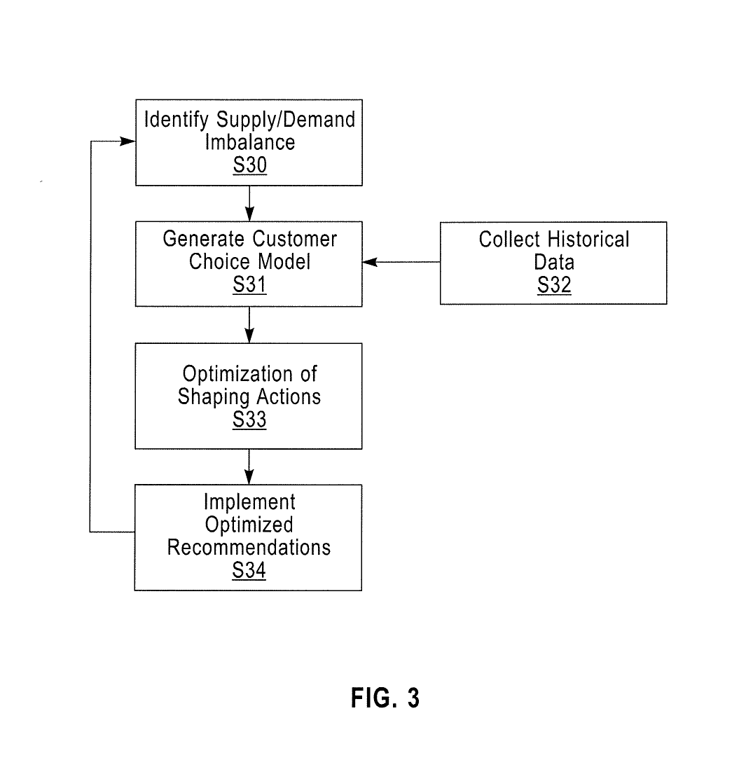

An example of the above-described approach is summarized below with reference to FIG. 3, which is a flow chart illustrating an approach for automatically balancing supply and demand using demand-shaping action in accordance with exemplary embodiments of the present invention.

First, a supply/demand imbalance may be identified (Step S30). A supply/demand imbalance may be, for example, a condition in which insufficient end products are on-hand or are otherwise scheduled to arrive to satisfy anticipated or observed demand. The cause of the imbalance may be due to a shortage in a component of the end product, unexpectedly large demand, or other supply/distribution constraints.

When an imbalance has been identified, a customer choice model may be generated (Step S31). As described above, the customer choice model may predict, for each potential customer or groups thereof, likelihoods of effective substitutions for each product pair for each available shaping action. This model may be based on actual collected data relating to customer choices observed in commerce. Thus, historical data may be collected (Step S32) prior to generating the customer choice model (Step S31). The historical data may include, for example, data pertaining to purchases by customers based on pricing and shaping actions taken, data pertaining to supplier reliability, forecast precision, and precision of the customer choice model. Historical data may also include, for example, business rules for demand shaping actions and costs for backlogs, inventory held and production margins.

Then, optimal shaping actions may be determined by optimizing shaping action to balance supply and demand (Step S332). The objective of the optimization problem may be to minimize potentially lost profits that may result from insufficient supply. The optimization may be based on a stochastic view of demand forecasts and may be formulated as a Markov decision process.

Optimization may result in the providing of demand shaping recommendations such as promotional offerings or the utilization of other known demand-shaping leavers. The optimized recommendations may then be implemented (Step S34) either automatically or manually. Thereafter, the method may be repeated so that new supply/demand imbalanced may be identified and/or the shaping action recommendations may be iteratively improved.

The identification of supply/demand imbalance, the collection of historical data, the generation of the customer choice model, the optimization of the shaping actions and in some cases the implementation of the optimized recommendations may be performed using one or more computer systems. Examples of suitable computer systems for performing these steps and the other steps discussed herein are provided below.

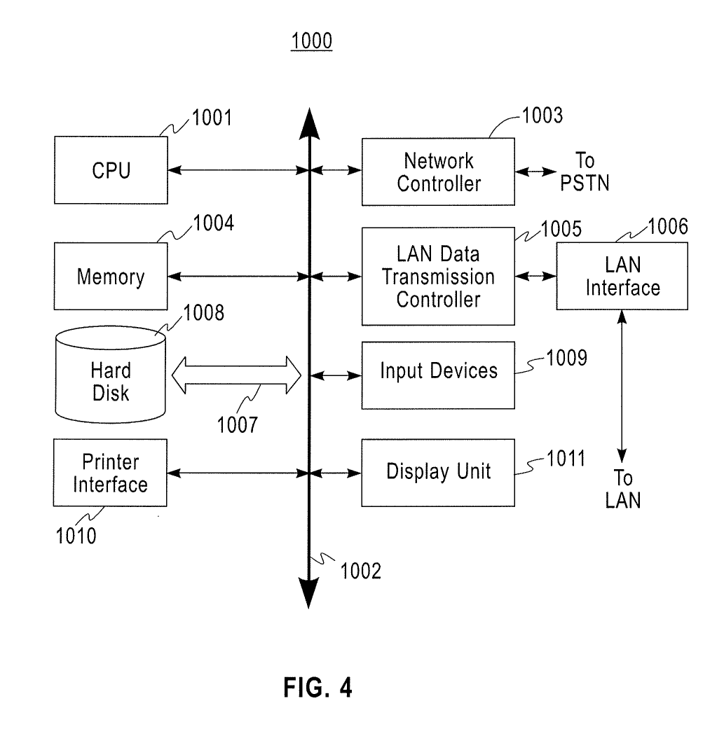

FIG. 4 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus to provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

1. A method for balancing supply and demand for a product using demand-shaping action, comprising:
identifying an imbalance between supply and demand for a given product;
generating a customer choice model based on collected historical sales data pertaining to the given product and at least one product similar to the given product, the customer choice model configured to estimate, for a given customer or group of customers, a likelihood of effecting a substitution between each product pair of the given product and the at least one product similar to the given product, for each of one or more available demand shaping actions; and
automatically selecting one or more of the available demand shaping actions to minimize an estimate of revenue shortfall or inventory holding costs resulting from the identified imbalance between supply and demand.

2. The method of claim 1, wherein automatically selecting one or more of the available demand shaping actions includes optimizing selection of demand shaping actions to maximize profit from the combined sale of the given product and the at least one product similar to the given product.

3. The method of claim 2, wherein the optimizing is performed based on a stochastic view of demand forecasts.

4. The method of claim 2, wherein the optimizing utilizes a Markov decision process.

5. The method of claim 1, wherein the identified imbalance between supply and demand for the given product includes determining that an estimated availability of the product is insufficient to meet an estimated demand for the product or determining that an estimated availability of the product is substantially greater than the estimated demand for the product.

6. The method of claim 1, wherein the collected historical sales data includes past customer purchase history.

7. The method of claim 1, wherein the collected historical sales data includes data pertaining to effectiveness of the available demand shaping actions in influencing customer preferences related to the given product and the at least one product similar to the given product.

8. The method of claim 1, wherein the one or more available demand shaping actions includes reducing a price of the given product or the at least one product similar to the given product or altering a stated lead-time or availability status of the given product or the at least one product similar to the given product.

9. The method of claim 1, wherein the one or more available demand shaping actions includes offering additional products or services along with the purchase of the given product or the at least one product similar to the given product or altering a stated lead-time or availability status of the given product or the at least one product similar to the given product.

10. The method of claim 1, wherein the one or more available demand shaping actions includes providing information comparing the given product to the at least one product similar to the given product.

11. The method of claim 1, wherein the one or more available demand shaping actions includes increasing the price of the given product or the at least one product similar to the given product.

12. The method of claim 1, additionally comprising implementing the selected one or more of the available demand shaping actions.

13. A method for balancing supply and demand for a product using demand-shaping action, comprising:
identifying when an estimated quantity demanded for a given product exceeds an ability to manufacture the product within a window of time due to limited availability of at least one component of the given product or when an estimated quantity demanded for the given product falls substantially short of a planed supply of the product;
generating a customer choice model based on collected historical sales data pertaining to the given product and at least one product similar to the given product, the customer choice model configured to estimate, for a given customer or group of customers, a likelihood of effecting a substitution between each product pair of the given product and the at least one product similar to the given product, for each of one or more available demand shaping actions; and
automatically selecting one or more of the available demand shaping actions to promote customer substitution from the given product to the at least one product similar to the given product.

14. The method of claim 13, wherein the at least one product similar to the given product does not include the at least one component having limited availability.

15. The method of claim 13, wherein automatically selecting one or more of the available demand shaping actions includes optimizing selection of demand shaping actions to maximize profit from the combined sale of the given product and the at least one product similar to the given product.

16. The method of claim 15, wherein the optimizing is performed based on a stochastic view of demand forecasts.

17. The method of claim 15, wherein the optimizing utilizes a Markov decision process.

18. The method of claim 14, wherein the collected historical sales data includes past customer purchase history.

19. The method of claim 14, wherein the collected historical sales data includes data pertaining to effectiveness of the available demand shaping actions in influencing customer preferences related to the given product and the at least one product similar to the given product.

20. The method of claim 14, wherein the one or more available demand shaping actions includes reducing a price of the given product or the at least one product similar to the given product or altering a stated lead-time or availability status of the given product or the at least one product similar to the given product.

21. The method of claim 14, wherein the one or more available demand shaping actions includes offering additional products or services along with the purchase of the given product or the at least one product similar to the given product or altering a stated lead-time or availability status of the given product or the at least one product similar to the given product.

22. The method of claim 14, wherein the one or more available demand shaping actions includes providing information comparing the given product to the at least one product similar to the given product.

23. The method of claim 14, wherein the one or more available demand shaping actions includes increasing the price of the given product or the at least one product similar to the given product.

24. The method of claim 13, additionally comprising implementing the selected one or more of the available demand shaping actions.

25-48. (canceled)
